(19) United States
(12) Patent Application Publication
(10) Pub. No.: US 2012/0159123 A1
(43) Pub. Date: Jun. 21, 2012

(54) CSTATE BOOST METHOD AND APPARATUS

(75) Inventors: Samuel D. Naffziger, Fort Collins, CO (US); John P. Petry, San Diego, CA (US); Kiran Bondalapati, Los Altos, CA (US)

(73) Assignee: ADVANCED MICRO DEVICES, INC., Sunnyvale, CA (US)

(21) Appl. No.: 12/971,734

(22) Filed: Dec. 17, 2010

(51) Int. Cl. G06F 9/32

(52) U.S. Cl. 712/37; 712/E09.074

(57) ABSTRACT

A central processing unit (processor) having multiple cores and a method for controlling the performance of the processor. The processor includes a first storage location configured to store a first threshold associated with a first boost performance state (P-State). The processor also includes logic circuitry configured to increase performance of active processor cores when an inactive processor core count meets or exceeds the first threshold. The processor may also include a second storage location configured to store a second threshold associated with a second boost P-State. The logic circuitry may be configured to compare the inactive processor core count to the first and second thresholds, select one of the first and second boost P-States and increase performance of active processor cores based on the selected boost P-State.

### FIELD OF INVENTION

This invention relates to processor performance control apparatus and methods.

### BACKGROUND

The Advanced Configuration and Power Interface (ACPI) specification provides a standard for operating system-centric device configuration and power management. The ACPI specification defines various “states” as levels of power usage and/or features availability. ACPI states include: global states, (e.g., G0-G3), device states, (e.g., D0-D3), processor states, (e.g., C0-C3), and performance states, (e.g., P0-Pn). The operating system and/or a user may select a desired processor state and a desired performance state. P-States are generally associated with fixed processor core frequency and voltage values. In a multi-core processor, the fixed frequency and voltage values are selected assuming that all processor cores are operating with 100% load. Such an arrangement does not maximize the performance of active processor cores when some processor cores are idle.

### SUMMARY OF THE EMBODIMENTS

A central processing unit (processor) having multiple cores and a method for controlling the performance of the processor are presented. The processor includes a first storage location configured to store a first threshold associated with a first boost performance state (P-State). The processor also includes logic circuitry configured to increase performance of active processor cores when an inactive processor core count meets or exceeds the first threshold. The processor may also include a second storage location configured to store a second threshold associated with a second boost P-State. The storage locations may be programmable. The logic circuitry may be configured to compare the inactive processor core count to the first and second thresholds, select one of the first and second boost P-States and increase performance of active processor cores based on the selected boost P-State.

The processor may also include a core performance manager configured to increase performance of active processor cores by adjusting processor core frequency or core voltage. A third storage location may be provided to store the inactive processor core count. The logic circuitry may be configured to detect inactive processor cores and update the inactive processor core count. The logic circuitry may be configured to receive a boost processor state (C-State), wherein the first boost P-State is associated with the boost C-State.

The processor may include a plurality of storage locations configured to store thresholds for a plurality of boost P-States configured in priority order. The logic circuitry may be configured to select one of the plurality of boost P-States based on the inactive processor core count. The processor may have a number of processor cores, wherein a maximum number of boost P-States is less than the number of processor cores. The plurality of boost P-State threshold may be processed in descending order. The plurality of boost P-State thresholds may be configured such that at least one boost P-State threshold is associated with a range of inactive processor core counts.

### BRIEF DESCRIPTION OF THE DRAWINGS

FIG. 1 is a block diagram showing a variety of Advanced Configuration and Power Interface (ACPI) states;

FIG. 2 is a state diagram including a new C-State, CStateBoost;

FIG. 3 is a block diagram of a multi-core processor; and

FIG. 4 is a flowchart showing operation of the Boost Logic.

### DETAILED DESCRIPTION OF THE EMBODIMENTS

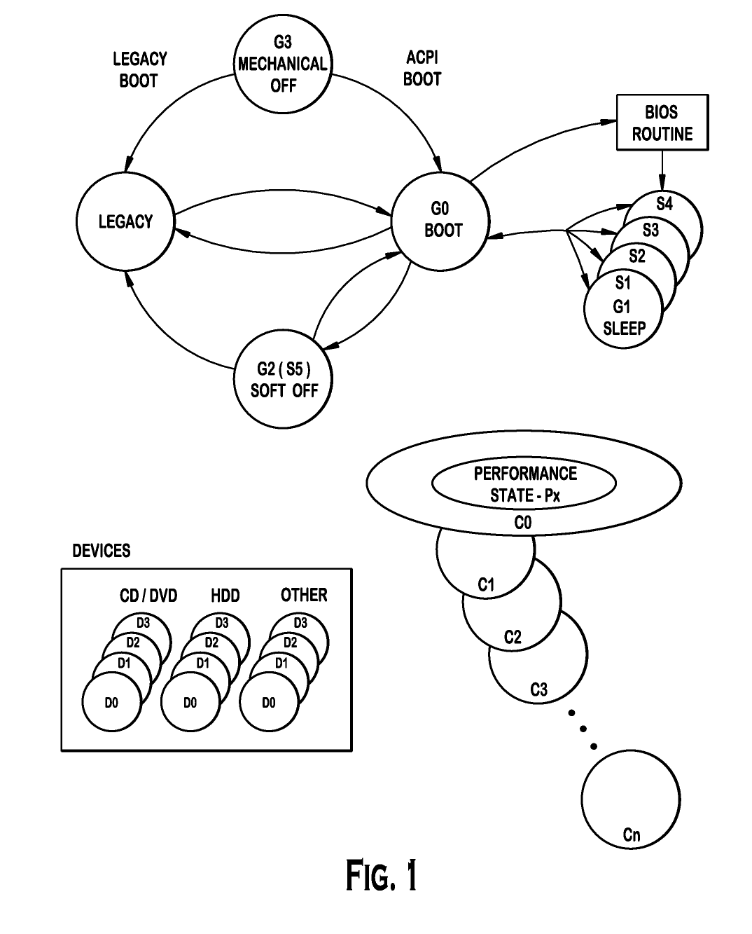

FIG. 1 is a bock diagram illustrating a variety of Advanced Configuration and Power Interface (ACPI) states. The ACPI specification defines various “states” as levels of power usage and/or features availability. ACPI states include: global states, (e.g., G0-G3), device states, (e.g., D0-D3), processor states, (e.g., C0-C3), and performance states, (e.g., P0-Pn). Some global states may be further divided into a plurality of sub-states, (e.g., G1 is divided into S1-S4 sleep states). Device states may be associated with a plurality of devices such as devices CD/DVD drives, hard disk drives and other devices. When operating normally, a system will be in the G0(S0) state with a C0 processor state.

While operating in the C0 state, a given processor core may also be associated with one of several performance states or “P-States” (P0-Pn). P0 is typically the highest-performance state. P1-Pn are successively lower-performance states. Typically n is no greater than 16. Each P-State is associated with a processor core operating frequency and core voltage, (e.g., V_{core}). It should be understood that the actual power dissipation of a given processor, single or multi-core, when operating with a fixed frequency and core voltage, will vary with load. Multi-core processor packages are limited by the amount of Electrical Design Current (EDC) that the voltage regulator may supply. The operating frequency and core voltage for the P0 state is selected assuming 100% loading on all processor cores. For example, with all processor cores operating in a P0 state and 100% load, a given processor will use approximately the maximum allowable EDC. This same processor operating in a P0 state with only a single core operating at 100% and the other cores are idle cannot take advantage of remaining EDC headroom. This may result in inefficient use of available EDC headroom when one or more processor cores are idle.

In order to leverage EDC headroom, a new boost state may be defined. In this state, active processor cores may utilize available EDC headroom to provide higher performance in those processor cores which are idle. This may result in higher overall system performance under less than full load.

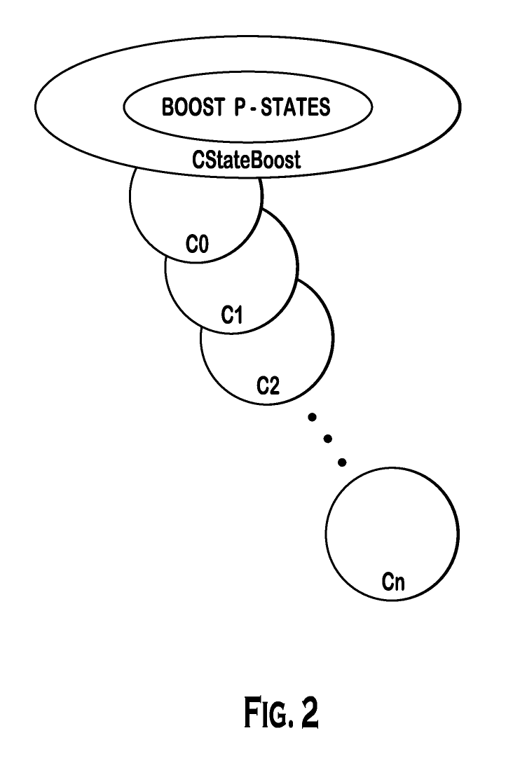

FIG. 2 is a state diagram including a new Boost C-State, CStateBoost, associated with one or more Boost P-States. The maximum number of Boost P-States may be less than or equal to m−1, where m is the number of processor cores in a die. These additional Boost P-States are not visible to the operating system and have higher performance than the highest operating system visible P-State associated with the C0 state, (e.g., in most cases P0). Boost P-States are available when one or more processor cores are idle, (e.g., in halt or power gated).

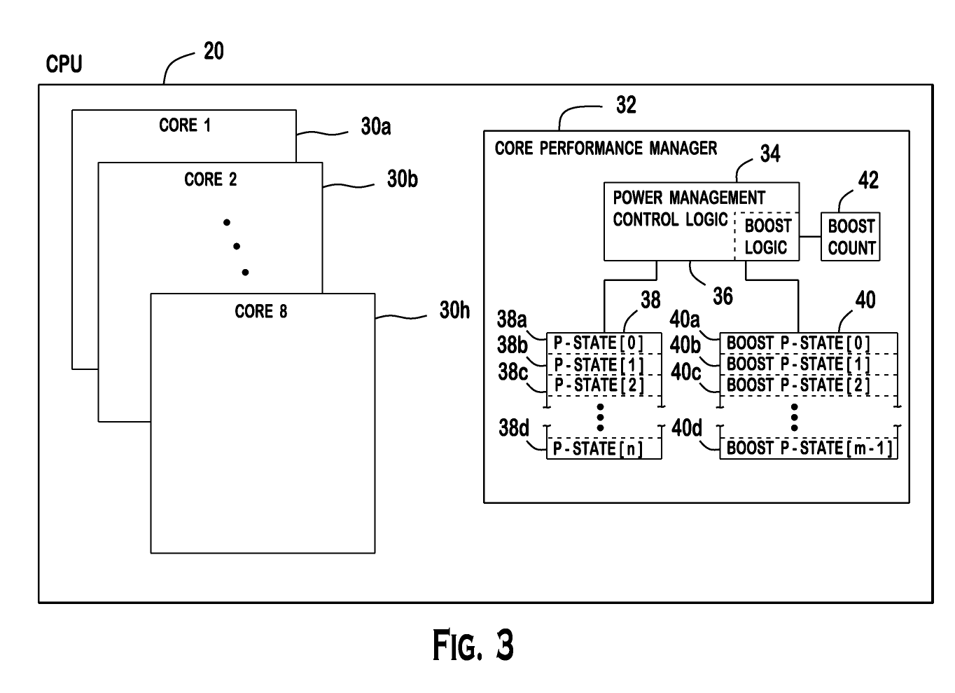

FIG. 3 shows an example multi-core processor 20 with eight (8) processor cores 30a, 30b . . . 30h. It should be understood that fewer or more processor cores may be used with departing from the scope of this disclosure. The processor 20 has a core performance manager 32. The core performance manager 32 may be located in a variety of locations such as the north bridge and may also be located on the processor die or elsewhere. The core performance manager 32 includes power management control logic 34 configured for ACPI power management. For example, the power management control logic 34 may access one or more storage locations 38 configured with standard P-State information. Storage locations 38a-38d may be configured to store the voltage and frequency values for supported P-States.

The power management control logic 34 also includes boost logic configured to manage operation of the processor in the Boost C-State. The power management control logic 34 may access one or more storage locations 40 configured to store the Boost P-State information.

Storage locations 40 may be programmable, for example a set of m−1 registers. In this example, with eight processor cores, a maximum of seven registers may be used. Each register is configured with a threshold number of inactive cores. Table 1 shows a sample configuration:

TABLE 1

| Boost Performance | Threshold | |
|---|---|---|
| State | Value | Description |
| Boost P-State-0 | 7 | Highest possible Boost P-State |
| | | 7 processor inactive (1 processor |
| | | core active) |
| Boost P-State-1 | 6 | Next highest Boost P-State |
| | | 6 processor cores inactive (2 |
| | | processor cores active) |
| Boost P-State-2 | 4 | Next highest Boost P-State |
| | | 4-5 processor cores inactive (3-4 |
| | | processor cores active) |
| Boost P-State-3 | 1 | Next highest Boost P-State |
| | | 1-3 processor cores inactive (5-7 |
| | | processor cores active) |
| • • • | | |
| Boost P-State-[m−1] | 0 | N/A |

In the example above, Boost P-State-0 is associated with a threshold of 7 and is available when 7 processor cores are inactive. Boost P-State-1 is associated with a threshold of 6 and is available when 6 processor cores are inactive. Boost P-State-2 is associated with a threshold of 4 and is available when 4-5 processor cores are inactive. Boost P-State-3 is associated with a threshold of 1 and is available when 1-3 processor cores are inactive. The remaining Boost P-States are reserved for future use. It should be understood that Boost P-State thresholds may be selected in a variety of configurations and that fewer or additional Boost P-States may be defined.

In general, the Boost Logic 36 is configured to track the number of inactive processor cores. Boost Logic 36 may access storage location 42 for storage of a boost count, (e.g., inactive processor core count). Boost Logic 36 is also configured to select the appropriate Boost P-State based on the boost count.

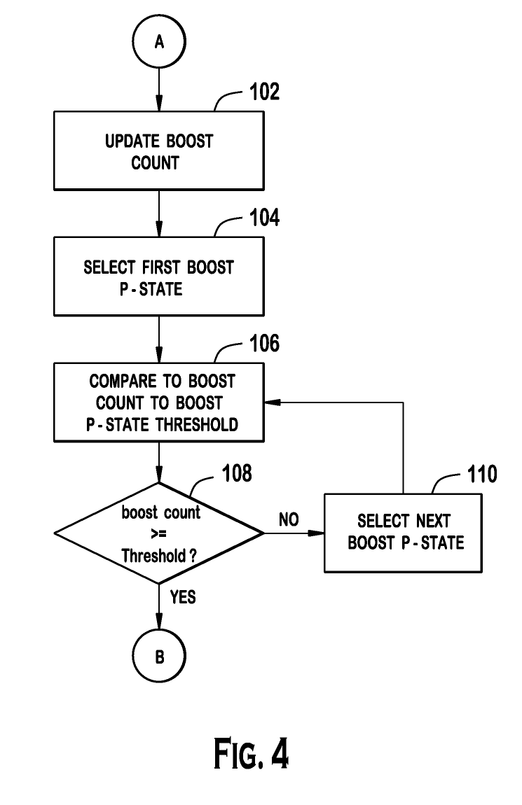

FIG. 4 is a flowchart showing operation of the Boost Logic 36. It should be understood that any flowcharts contained herein are illustrative only and that other entry and exit points, time out functions, error checking functions and the like (not shown) would normally be implemented in a typical system. Any beginning and ending blocks are intended to indicate logical beginning and ending points for a given subsystem that may be integrated into a larger device and used as needed. The order of the blocks may also be varied without departing from the scope of this disclosure. Implementation of these aspects is readily apparent and well within the grasp of those skilled in the art based on the disclosure herein.

Boost P-State thresholds are enforced in a priority order favoring the highest possible Boost P-State. The Boost P-State and processor performance will generally move up or down based on the boost count. Boost P-State processing begins with block A. Processing will commence at this block only when the processor is operating in the Boost C-State. It should be understood that the operations shown in FIG. 4 may be carried out on a periodic or intermittent basis. The boost logic 36 is configured to update the boost count to reflect the number of inactive processor cores as shown by block 102. The highest Boost P-State, (e.g., Boost P-State-0), is selected by default as shown by block 104. The boost count is compared to the Boost P-State-0 threshold as shown by block 106. If the boost count is greater than or equal to the Boost P-State-0 threshold (block 108), then the Boost P-State-0 will remain selected and processing may continue as shown by block B.

If the boost count is less than the Boost P-State-0 threshold, then the threshold for the next Boost P-State is selected, (e.g., Boost P-State-1), as shown by block 110. The boost count is compared to the Boost P-State-1 threshold as shown by block 106. If the boost count is greater than or equal to the Boost P-State-1 threshold, then the Boost P-State-1 will remain selected and processing may continue as shown by block B. This process is continued until the last Boost P-State is selected. Once a new Boost P-State is selected, the boost logic 36 is configured to change the core frequency and/or voltage in the active processor cores if the new P-state is different than the current one.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A processor having multiple cores, the processor comprising:
a first storage location configured to store a first threshold associated with a first boost performance state (P-State); and
logic circuitry configured to increase performance of active processor cores when an inactive processor core count meets or exceeds the first threshold.

2. The processor of claim 1 wherein the first storage location is programmable.

3. The processor of claim 1 further comprising a second storage location configured to store a second threshold associated with a second boost P-State, the logic circuitry being configured to compare the inactive processor core count to the first and second thresholds, select one of the first and second boost P-States and increase performance of active processor cores based on the selected boost P-State.

4. The processor of claim 1 further comprising a core performance manager configured to increase performance of active processor cores by adjusting a processor core frequency or core voltage.

5. The processor of claim 1 further comprising a third storage location configured to store the inactive processor core count.

6. The processor of claim 1 wherein the logic circuitry is configured to detect inactive processor cores and update the inactive processor core count.

7. The processor of claim 1 wherein the logic circuitry is configured to decrease performance of active processor cores when an inactive processor core count is less than the first threshold.

8. The processor of claim 1 wherein the logic circuitry is configured to detect a boost processor state (C-State), wherein the first boost P-State is associated with the boost C-State.

9. The processor of claim 1 further comprising a plurality of storage locations configured to store thresholds for a plurality of boost P-States configured in priority order, the logic circuitry being configured to select one of the plurality of boost P-States based on the inactive processor core count.

10. The processor of claim 9, wherein the processor has a number of processor cores and a maximum number of boost P-States less than the number of processor cores.

11. The processor of claim 9, wherein the thresholds for the plurality of boost P-States are processed in descending order.

12. The processor of claim 9, wherein the plurality of boost P-State thresholds are configured such that at least one boost P-State threshold is associated with a range of inactive processor core counts.

13. A method of controlling the performance of a central processing unit (processor) having multiple cores, the method comprising:
increasing performance of active cores when an inactive core count meets or exceeds a first threshold associated with a first boost performance state (P-state).

14. The method of claim 13 further comprising storing a first threshold associated with the first boost P-State.

15. The method of claim 14 further comprising
storing a second threshold associated with a second boost P-State;
comparing the inactive processor core count to the first and second thresholds; and
selecting one of the first and second boost P-States and increasing performance of active processor cores based on the selected boost P-State.

16. The method of claim 13 further comprising increasing performance of active processor cores by adjusting processor core frequency or core voltage.

17. The method of claim 13 further comprising storing the inactive processor core count.

18. The method of claim 13 further comprising decreasing performance of active processor cores when the inactive processor core count is less than the first threshold.

19. The method of claim 13 further comprising detecting inactive processor cores and updating the inactive processor core count.

20. The method of claim 13 further comprising detecting a boost processor state (C-State), wherein the first boost P-State is associated with the boost C-State.

21. The method of claim 13 further comprising storing a plurality of thresholds for a plurality of boost P-States configured in priority order, and selecting one of the plurality of boost P-States based on the inactive processor core count.

22. The method of claim 21, wherein the processor has a number of processor cores and a maximum number of boost P-States less than the number of processor cores.

23. The method of claim 21, wherein the plurality of boost P-State threshold are arranged in descending order.

24. The method of claim 21, wherein the plurality of boost P-State thresholds are configured such that at least one boost P-State threshold is associated with a range of inactive processor core counts.

25. A computer readable media including hardware design code stored thereon, and when processed generates other intermediary data to create mask works for a processor that is configured to perform a method of controlling the performance of a central processing unit (processor) having multiple cores, the method comprising:
increasing performance of active cores when an inactive core count meets or exceeds a first threshold associated with a first boost performance state (P-state).
